(19) United States
(12) Patent Application Publication
(10) Pub. No.: US 2002/0009293 A1
(43) Pub. Date: Jan. 24, 2002

(54) HDTV video server

(76) Inventor: Kipp A. Aldrich, San Rafael, CA (US)

Correspondence Address: IRELL & MANELLA LLP, Suite 900, 1800 Avenue of the Stars, Los Angeles, CA, 90067, US

(21) Appl. No.: 09/777,272

(22) Filed: Feb. 5, 2001

Related U.S. Application Data
(60) Provisional application No. 60/180,098, filed on Feb. 3, 2000.

(51) Int. Cl. H04N 5/91

(52) U.S. Cl. 386/123

(57) ABSTRACT

The present invention may operate as a bridge between computer file systems and commercially available HDTV television equipment. It exploits high bandwidth, high transaction rate system design techniques to achieve high levels of performance. It converts, in real-time, the YCbCr colorspace signal of HDTV equipment to the highest quality RGB file formats necessary for computer-based applications. The system is completely transparent to external control systems, behaving as any standard VTR would. It allows for insert editing and playback of frames, loops, and segments, in a completely non-linear fashion. It can be controlled from any standard edit controller, including VTR front panels, allowing for easy integration into existing production and post-production environments. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or meaning of the claims.

### RELATED APPLICATIONS

This application claims priority from copending U.S. provisional patent application serial No. 60/180,098 filed Feb. 3, 2000.

### BACKGROUND OF THE INVENTION

1. Field of the Invention

This invention relates to video production and processing, and more specifically to real-time processing RGB format, high definition television (HDTV) image files for HDTV production equipment.

2. Description of the Prior Art

Born of feature film special effects roots, electronic cinematography (EC) is a product of computer graphics imaging (CGI) systems and software. The need to manipulate elemental imagery as individual computer files is inherent in digital feature film production. Principle photography for a feature film may produce as much as 20 hours of 24 frames per second (fps) digital imagery. This is more than 17 million frames, each of which needs to be made available for CGI processing and dailies review. Iterative dailies review and compositing will produce many tens of hundreds of thousands of frames per day.

The costs associated with software conversion of digital HDTV frames into computer files are often hidden. Traditional conversions have relied upon software techniques and are processor and memory intensive. Each transversal of the production pipeline by a frame may entail many such conversions. Every effort to reduce, or eliminate, the use of processor time for these conversions pays dividends many times over by freeing valuable processors for other more directly billable software tasks.

A Redundant-Array-of-Inexpensive-Disks (RAID) configuration is not used because RAID systems operate at diminished capacities and rates during failure modes. This is anathema to real-time playback and recording. Though the lack of redundant data seems a malady, in practice it is not really so. In the event of a disk failure, the offending disk is replaced, and the frames re-edited to, or from, the reconstructed file system. This is far faster than the downtime encountered during RAID rebuilds. Additionally, RAID arrays must also calculate and write extra parity data to the array. This can cause increased write times compared to non-RAID arrays. When transaction times in the milliseconds are important, an increase in access time can be too much, causing a loss of frames.

The native colorspace of HDTV is YCbCr; a ⅔ compressed colorspace that shares adjacent pixel color information, reducing the total storage size for each frame. Conventional CGI software generally uses linear RGB colorspaces that may require more than 3 times the storage of a YCbCr frame. Also, linear RGB colorspaces may require gamma correction to overcome the gamma introduced by video equipment.

Some mechanism must exist to convert between HDTV's YCbCr and CGI's RGB formats. Conventional conversion techniques are software based, and while this works, it is time consuming and requires many processor-hours daily, and most certainly does not support real-time operation. What is needed is an efficient method and apparatus to transfer and convert frames between HDTV equipment and CGI systems in real-time.

### SUMMARY OF THE INVENTION

The present invention may provide a real-time technique for processing YCbCr images into RGB format files. An HDTV video server according to the present invention translates YCbCr images to RGB12 image files and includes a several parallel memory paths and parallel storage devices to minimize data bottlenecks.

In another aspect of the present invention a method of real-time translation of YcbCr images into RGB images includes the steps of capturing a high-density video image in a first data format, compiling the high definition video image in a second data format and writing the high definition video image as a stripped data file.

In a still further aspect of the present invention, an HDTV video server according to the present invention includes means for translating the high definition video image in a first data format to a high definition video image in a second data format, means for filtering the high definition video image to eliminate translation artifacts, means for correcting the high definition video image, means for packing the high definition video image in a second data format packing mode, means for writing the high definition video image as a stripped data file, means for reading the stripped data file and compiling the high definition video image in the second data format, and means for providing the high definition video image in the second data format to a network or other device.

These and other features and advantages of this invention will become further apparent from the detailed description and accompanying figures that follow. In the figures and description, numerals indicate the various features of the invention, like numerals referring to like features throughout both the drawings and the description.

### BRIEF DESCRIPTION OF THE DRAWINGS

FIG. 1 is a table listing data rates for various formats and frame rates.

FIG. 2A is a table showing bit packing for YCbCr8 format.

FIG. 2B is a table showing bit packing for YCbCr10 format.

FIG. 2C is a table showing bit packing for RGB8 format.

FIG. 2D is a table showing bit packing for RGB10 format.

FIG. 2E is a table showing bit packing for RGB12 format.

FIG. 3 is a block diagram of a network incorporating a video server according to the present invention.

FIG. 4 is a block diagram of a video server according to the present invention.

FIG. 5 is a flow chart for frame buffer data processing according to the present invention.

FIG. 6 is a diagram of the card layout for an HDTV video server according to the present invention.

### DETAILED DESCRIPTION OF THE PREFERRED EMBODIMENT(S)

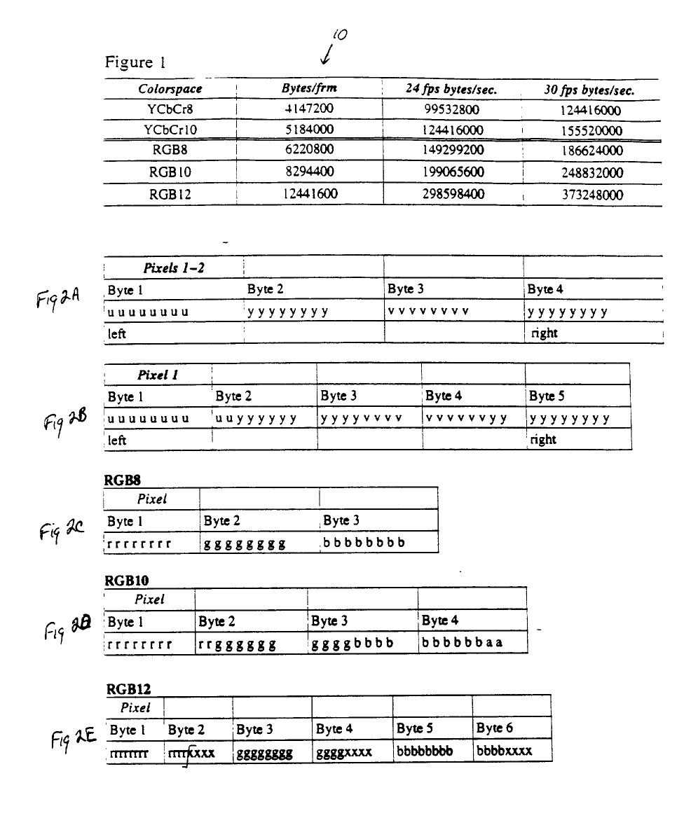

Referring now to FIG. 1, overall data rates for various modes of packing and colorspace are outlined in table 10. These data rates are the actual image payload data rates only. Operating system and application I/O may further burden the data rates shown. Transaction rates are defined as the frame rate to process individual frames, and at 24 fps, frames must be read or written every ˜41 milli seconds (msecs).

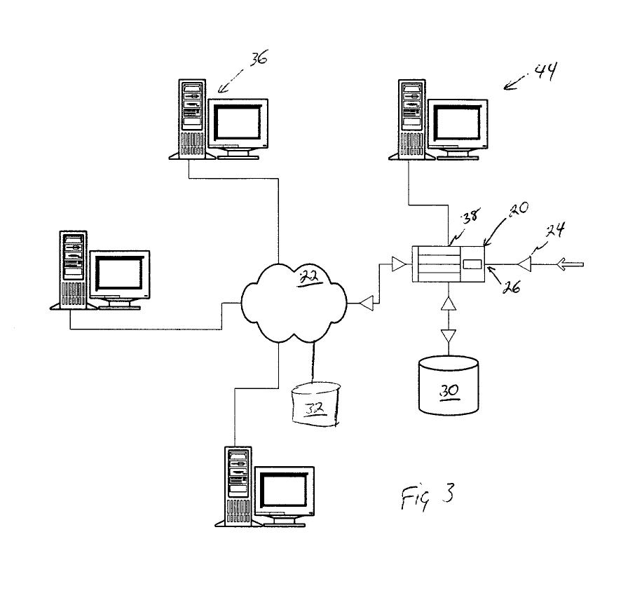

FIGS. 2A-2F shows various forms of packing, or the manner in which bits are stuffed together to represent pixel data. Packing impacts storage size significantly. Referring now to FIG. 2A, eight bit YCbCr files require ⅔ the storage of the their 8 bit RGB cousins of FIG. 2C. Higher color depth RGB files such as RGB12 require even more bandwidth. The RGB12 packing mode of FIG. 2E is the currently preferred packing mode of the present invention. With 1920 pixels, 1080 lines, and 6 bytes per pixel, each frame requires more than 12.5 megabytes (MB) of storage and provides maximum color depth.

There are two basic methods of writing high data rate files according to the present invention: open and close per frame (OCF), and streaming. OCF has the advantage of creating individual computer files for each frame, but the disadvantage of dramatically increasing the transaction rate requirements. Single frame files must be opened, written/read, and closed in a timely fashion so that each and every frame is handled without loss or delay. The streaming approach opens and closes only a single file per shot, creating one very large file, storing or retrieving individual frames by offsetting into the file. Streaming is kinder to the file system because only one open and close is encountered per shot but produces single large files of collections of frames. At the desired RGB12 color depth, the streaming method produces files of ˜18 GB/minute.

A currently preferred embodiment of the present invention uses OCF methods for two reasons: 1) moving massive streamed files over a network infrastructure is time consuming and problematic, and 2) extracting individual frames from a single massive streamed file requires further processing. A secondary downstream process must extract or insert frames to gain access to individual frames. These hindrances complicated the design goal of real-time access to frames.

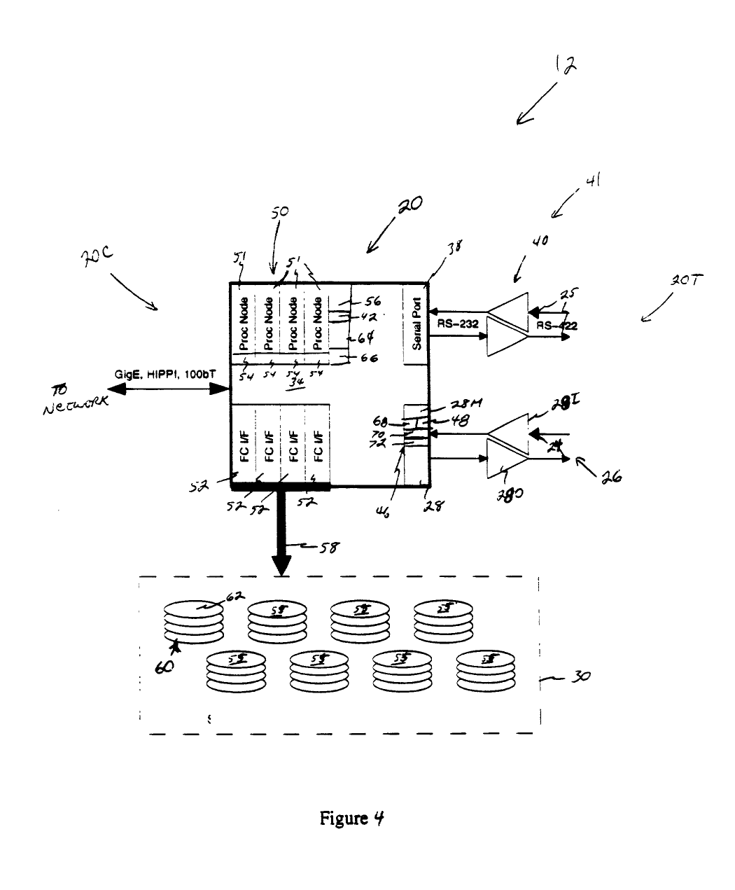

For an RGB12 system according to the present invention, and considering data rates, transaction rates, and packing, at 24 fps, the data rate is ˜300 MB/sec., or about ˜18 GB/minute. Individual frames of ˜12.5 MB must be stored or retrieved every 41.8 msec. Referring now to FIG. 4, image data 24 must also transit from frame buffer 28 into memory 30, and then from memory 30 to storage such as network storage 32, producing an aggregate bandwidth across computer bus 34 of twice the expected data rate. This results in a total bandwidth requirement of 600 MB/sec.

Referring now to FIG. 3, a high-resolution video processor and capture device 20 according to the present invention, may be connected to network 22 as shown. Network 22 may include one or more users 36 and storage 32. Data 24 may be applied to high-resolution video processor and capture device 20 using interface 26. Memory 30 is provided as local memory. Control information 25 may be provided through serial port 38 which may include an appropriate converter such as converter 40 for conversion between RS-232 and RS-422.

To achieve these staggering data rates, careful attention must be given not only to the numbers of CPUs, disks, frame buffers, and memory sizes, but also to platform backplane design and avoidance of I/O bottlenecks.

Referring now to FIG. 4 the detail block diagram of high-resolution video processor and capture device 20 includes the following functional blocks:

4 node processor system 50 such as the SGI Origin 2000;

Frame Buffer 28 such as the SGI XT-HD Frame Buffer Card (with outboard serial/parallel converters);

Computer bus 34 or backplane such as the SGI XIO High-speed backplane;

Multiple memory nodes 54, or frame buffers;

Multiple Fiber Channel (FC) interface boards 52;

“Stripped” multiple parallel disk drive storage sub-systems such as disk drive 55;

RS422 control port 40.

In a currently preferred embodiment of the present invention, processor system 50 may be an SGI 4-node Origin 2000 platform, chosen for it's high-speed XIO bus 34. Frame buffer 28 may be an SGI XT-HD frame buffer suitable for its outstanding RGB conversion ability, especially in light of its capability to deliver the desired RGB12 packing mode. Multiple processor cards 51 provide more memory nodes 54 that enable parallel memory access. Fiber Channel interface boards 52 were chosen for their ease of use and high throughput. Other suitable components may be used.

The basic system is a bridge between two worlds. The two sides are split between computer file system side 20C, and television production side 20T. On computer side 20C, network connectivity provides for network access to individual frames of HDTV material as RGB files. Multiple protocols such as gigabit ethernet, serial HIPPI, and switched 100 bT access may be used. On television production side 20T, high-resolution video processor and capture device 20 behaves as an industry standard VTR, interfacing to existing edit environments exactly as any VTR would. A proprietary RS422 software daemon 42 provides edit system operation. The video input and output may be routed to appropriate sources or destinations. Serial port 38 handles RS422 communications via RS232 to RS422 level converter 40 and routed with data 24 to appropriate control devices such as control/editor 44.

Frame buffer 28 acquires and or transmits the standard HDTV data streams at the necessary frame rates, converting the frames to, or from, the RGB colorspace, and providing image correction. In a currently preferred embodiment of the present invention an SGI XT-HD frame buffer operates with parallel I/O only, so outboard converters 28I and 28O may be necessary to accommodate SMPTE 292 HD SDI signals.

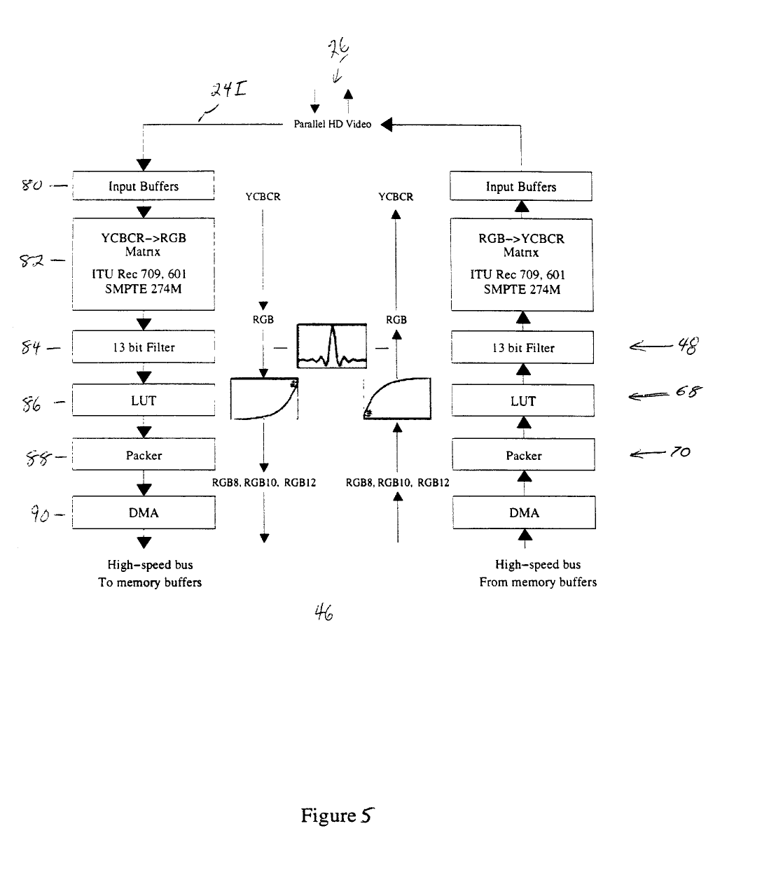

Referring now to FIG. 5, a block diagram of the data flow within frame buffer 28 is shown. At step 80 frame buffer 28 buffers the input data stream 24I before passing it to conversion matrix for conversion to the RGB colorspace in step 82. The frame buffer of the present invention supports three matrices, SMPTE 274M, ITU-BT Rec.709 and ITU-BT Rec.601, any one of which is selectable at initialization time. Other suitable conversion techniques may also be used. At step 84, data are passed to 13-bit filter 48 where ringing and edge artifacts inherent in colorspace conversions are diminished. At step 86 data are passed to transform block 68 which uses look-up-table(LUT) or other suitable techniques to map input values to new output values. It is during step 86 that gamma corrections, or other more esoteric mappings, may occur. Data 24I are passed to the packing block 70 at step 88, where data 24I is formatted for the requested packing mode such as RGB8, RGB10, or RGB12. The preferred packing mode is RGB12. At step 90, the data are transferred via DMA block 72 into or out of frame buffer memory 28M.

Throughput in a system such as system 12 is ultimately determined by the design of the backplane or computer bus 34. It must be capable of consistently transferring the total data rates shown in FIG. 1, without blocking or dropping data. In a currently preferred embodiment of the present invention, a SGI Origin XIO backplane adequately supports the RGB12 packing mode, any other suitable equipment may also be used. As shown in FIG. 1, using RGB12 at 24 fps, the bandwidth requirement is ˜300 MB/second. This means an aggregate throughput of ˜600 MB/sec., since each frame must transit the bus twice, once into memory, and thence to the storage sub-systems, This 600 MB/sec. rate is just under the published maximum threshold of operation of the XIO bus.

The application software provides frame buffers to receive frames from the storage sub-system or the HD frame buffer depending on whether frames are playing or recording. These buffers are evenly split across the available CPU nodes providing simultaneous parallel paths for data flow. This modular and adaptable design assures that no single bottleneck exists that will completely dominate the I/O process, and can be configured for optimal bandwidth and transaction rates for any given color depth. This mitigates the interaction of bandwidth, number of FC ports, and transaction rates.

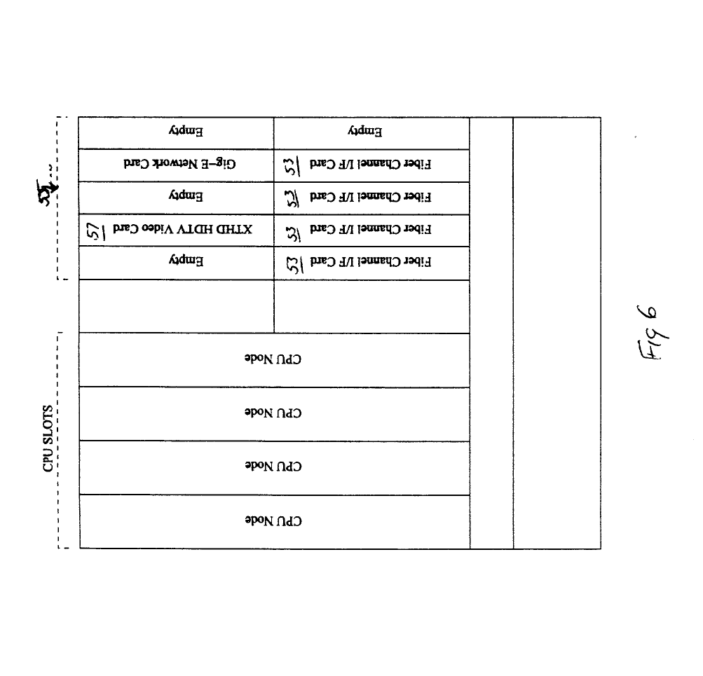

Referring now to FIG. 6, the relative layout of the cards of the present invention is shown. In high-speed designs careful attention must be paid to actually getting the throughput required to support the needed data rates. For instance, in this design, correct placement of the FC cards 53 in the chassis slots 55 with respect to frame buffer card 57 is critical. Incorrectly placing the FC cards will cause I/O imbalance, and the transfer rates at any single node may exceed the maximum and the system will produce tearing and flashing video.

The disk storage sub-system or memory 30 is the repository of inbound or outbound frames, data 24. It must have sufficient capacity to store the number of frames expected and it must be capable of the required bandwidth at the transaction rates of 24 and 30 fps. It must also be flexible and cost effective.

No single disk drive can support these data rates. Therefore multiple disk drives or memory nodes such as memory node 54 are “stripped”, or sequentially written, with each frame. The stripping process may be optimized using software 56 such as the SGI XFS file system. A single frame of data 24 is stripped across the array of disks 54, each disk shouldering its portion of the overall data in parallel with the others. With the appropriate number of drives, the tremendous data rate associated with RGB12 HDTV frame files can be accommodated. In a currently preferred embodiment of the present invention 32 50 GB hard drives or memory nodes 54 are used.

To optimize frame transfer between processor system 50 and memory 30, 8 FC pipes 58 are used, and at a data rate of ˜300 MB/sec., each stripe is responsible for storing about ˜37.5 MB of data per second. Each FC pipe 58 is connected to 4 50 GB drives, for a total storage of 1.6 TB. This provides for approximately 1.5 hours of RGB12 storage at 24 fps.

Another feature endemic to disk drives that must be mitigated is thermal recalibration. This process keeps heads properly aligned to data tracks. During thermal recalibration, disk I/O activity is suspended, producing image freezes or loss of frames. This is not a desirable feature and it is vital to eliminate or hide the thermal recalibration process. Many manufacturers hide the thermal recalibration between data access, but many do not. To achieve the high data throughput of the present invention it is necessary to use disk drives such as memory node 54 that perform thermal recalibration between data access.

Another element of the storage sub-systems that effects performance is file system logging. Using separate disk drives such as admin drive 60 for file log 62 prevents logging operations from interfering with realtime frame I/O. Journalizing file systems such as SGI's XFS write log files to maintain meta-data. By default, XFS uses a log on the same disks as the file system it is managing, but may optionally locate the log on entirely separate disks, any similarly suitable file system may also be used.

In a currently preferred embodiment of the present invention, the software portion of the system includes operating system 64 and it's libraries, and custom UNIX server daemon processes 66. A daemon is a process that runs in the background and performs a specified operation at predefined times or in response to certain events. The term daemon is a UNIX term, though many other operating systems provide support for daemons, though they're sometimes called other names. Windows, for example, refers to daemons and System Agents and services. Any suitable operating system may be used.

SGI's IRIX 6.5.5 is the OS used according to the present invention. It's dmedia library directly supports frame buffer 28 with drivers that provide the appropriate HDTV signals and packing modes, RGB conversions, look up table support, and frame buffer distribution. Daemon processes 66 acccording to the present invention use the SGI dmedia libraries to build HDTV video server 20.

Main daemon process 80 consists of multiple children processes, that run concurrently to execute user commands, RS422 serial control, frame transfers, and associated tasks. There are two main processes, the server itself, and an RS422 edit control module. With each request from a user, an additional child process is forked off to handle the actual realtime I/O of frames. Locking daemons prevent simultaneous server access. Routing daemons provide signal routing control that relieves operators from manually routing signals. Database daemons provide global shot and device control information. Each of the software processes makes extensive use of logging for troubleshooting and diagnosis, and cost accounting and usage reports.

The main server daemon is responsible for initializing the appropriate hardware and system resources. It runs at a high system priority to minimize contention by other system processes. After starting, it immediately spawns the RS422 child process, and then sits around waiting for user commands. User commands are received via a TCP/IP socket connection and can be transmitted from a variety of user interfaces. Commands and parameters may be sent from command lines, from shell scripts, from web based interfaces, and from high-performance GUI interfaces.

The RS422 daemon child process 42 is responsible for responding to industry standard editing control commands. Without process 42, editing system operation would be impossible. Using the SGI tserialio library, master/slave RS422 interface, interface 41, was constructed. Daemon process 42 maintains a virtual VTR state-machine that provides the control information necessary for all other daemons. The RS422 daemon runs continuously, providing for “always-on” status and timecode for edit controllers. Even if no playback or record command has been issued by the server daemon, the RS422 daemon is responsive. It behaves as if there were no “tape” in the “deck”. To shut down operations, issuing the eject command causes the child frame I/O server process to shutdown, and the main daemon to become available for further user commands.

Having now described the invention in accordance with the requirements of the patent statutes, those skilled in this art will understand how to make changes and modifications in the present invention to meet their specific requirements or conditions. Such changes and modifications may be made without departing from the scope and spirit of the invention as set forth in the following claims.

I claim:

1. A method for recording high definition video images in real time comprising the steps of:
acquiring a high definition video image in a first data format;
compiling the high definition video image in a second data format; and
writing the high definition video image as a stripped data file.

2. The method of claim 1 wherein acquiring a high definition video image in a first data format comprises:
acquiring a high definition video image in a YcbCr format.

3. The method of claim 1 wherein compiling the high definition video image in a second data format comprises:
compiling the high definition video image in an RGB format.

4. The method of claim 1 wherein compiling the high definition video image in a second data format further comprises:
compiling the high definition video image in the first data format;
translating the high definition video image in the first data format to a high definition video image in the second data format;
filtering the high definition video image to eliminate translation artifacts;
correcting the high definition video image; and
packing the high definition video image in a second data format packing mode.

5. The method of claim 4 wherein compiling the high definition video image in a first data format comprises:
compiling the high definition video image in a YcbCr format.

6. The method of claim 4 wherein translating the high definition video image in the first data format to a high definition video image in the second data format comprises:
translating the high definition video image in YcbCr format to a high definition video image in RGB format.

7. The method of claim 4 wherein packing the high definition video image in a second data format packing mode comprises:
packing the high definition video image in RGB12 format.

8. The method of claim 4 wherein translating the high definition video image in YcbCr format to a high definition video image in RGB format comprises:
using SMPTE 274M or ITU-BT Rec.709 or ITU-BT Rec.601 to translate the high definition video image from YcbCr format to a high definition video image in RGB format.

9. An apparatus recording high-density video images in real time comprising:
means for compiling a high definition video image in a first data format;
means for translating the high definition video image in the first data format to a high definition video image in a second data format;
means for filtering the second format high definition video image to eliminate translation artifacts;
means for correcting the second format high definition video image;
means for packing the second format high definition video image in a second data format packing mode
means for writing the packed high definition video image as a stripped data file;
means for reading the stripped data file and compiling the high definition video image in the second data format; and
means for providing the high definition video image in the second data format to a network.
